(19) United States
(12) Patent Application Publication
(10) Pub. No.: US 2012/0223908 A1
(43) Pub. Date: Sep. 6, 2012

(54) DISPLAY DEVICE

(75) Inventor: Mamoru Onda, Osaka (JP)

(73) Assignee: SHARP KABUSHIKI KAISHA, Osaka (JP)

(21) Appl. No.: 13/508,912

(22) PCT Filed: Jul. 27, 2010
(86) PCT No.: PCT/JP2010/004767

§ 371 Date: May 9, 2012

(30) Foreign Application Priority Data
Nov. 10, 2009 (JP) 2009-256643

(51) Int. Cl. G06F 3/041

(52) U.S. Cl. 345/173

(57) ABSTRACT

A display device (10) according to the present invention includes a display panel (1) and a transparent member (2). In the display device (10), a transparent resin sheet (3) to bond the display panel (1) and the transparent member (2) is arranged between the display panel (1) and the transparent member (2); and the display panel (1) and the transparent member (2) are unified in a shrinkable case (4) made of a heat shrink material. Furthermore, the shrinkable case (4) has a light blocking property. Furthermore, a plurality of shrinkable cases (4) unify the display panel (1) and the transparent member (2). Furthermore, the transparent member (2) is a touch panel.

### TECHNICAL FIELD

The present invention relates to a structure of a display device in which a display panel and a transparent member such as a touch panel is united.

### BACKGROUND ART

In a unified liquid crystal display device in which a liquid crystal panel and a touch panel are bonded and unified, if a layer of air (air bubbles) exists between the liquid crystal panel and the touch panel, interface reflection due to refractive index difference occurs and a display quality is degraded; therefore, a structure in which the layer of air (air bubbles) does not exists between the liquid crystal panel and the touch panel has been adopted.

For example, referring to FIG. 4, Patent Document 1 discloses a touch panel in which two insulating substrates 101 and 103 having conductive films 102 and 104, respectively, are bonded firmly to each other by a frame-shaped circumference part 105 such that the conductive films 102 and 104 face each other with a prescribed space therebetween. Then, the inner area of the circumference part 105 defines the visible area. Here, an adhesive layer 121 for mounting the touch panel on a liquid crystal panel 112 is placed only in the visible area excluding the circumference part 105 of the above-mentioned insulated substrate 101, and the touch panel is mounted on the mounting area of the liquid crystal panel 112 by pressing only the visible area from above. Since there is no large unevenness in the visible area where the adhesive layer 121 is placed, air bubbles and the like do not easily enter between the panels. Thus, Patent Document 1 purports to disclose high quality and reliable mounting of the touch panel on devices for use.

### RELATED ART DOCUMENT

### Patent Document

Patent Document 1: Japanese Patent Application Laid-Open Publication No. 2005-115729

### SUMMARY OF THE INVENTION

### Problems to be Solved by the Invention

However, even though the adhesive layer 121 is placed only in the visible area excluding the region of the circumference part 105 as in the liquid crystal display device of Patent Document 1, air bubbles are still generated by the existence of slight unevenness of the adhesive layer 121 itself. Thus, it was difficult to prevent air bubbles generation across the entire visible area. Furthermore, the surrounding adhesive layer 121 encircles the air bubbles generated between the liquid crystal panel and the touch panel. Therefore, it was difficult to push away the air bubbles to the outside of the visible area even if the air bubbles were squeezed out from above the touch panel. Thus, the conventional liquid crystal display device had the following problems: the air bubbles generation in the visible area was difficult to avoid; interface reflection of light occurred in the air bubbles portions due to refractive index difference; and as a result, the visibility in the visible area degraded.

Furthermore, the unified liquid crystal display device also had the following problems in productivity. When the touch panel and the liquid crystal panel were found faulty and the touch panel and the liquid crystal panel need to be separated and replaced with normal panels, it was not easy to separate the touch panel from the liquid crystal panel because the adhesive layer 121 is placed on the entire surface of the visible area and the touch panel and the liquid crystal panel are bonded firmly. Thus, a residue of the adhesive agent remained on the touch panel and on the liquid crystal panel after they were separated.

Moreover, there was also a problem in reliability. For example, the edge of the adhesive layer 121 was torn due to tilting and chipping developed on the edge of the adhesive layer 121, and the adhesive power of the adhesive layer 121 was weakened due to the aged deterioration of the adhesive agent in the adhesive layer 121. As a result, panels were separated and air bubbles newly were generated.

The present invention was devised taking the above-mentioned problems into account, and its purpose is to provide a display device with excellent display quality, productivity, and reliability.

### Means for Solving the Problems

A display device according to the present invention includes a display panel; a transparent member; a transparent resin sheet between the display panel and the transparent member for bonding the display panel and the transparent member; and a shrinkable case made of a heat shrink material that unifies the display panel and the transparent member therein. The shrinkable case may have a light blocking property. The shrinkable case may be provided plurally. The above-mentioned transparent member may be constituted of a touch panel.

### Effects of the Invention

The present invention can provide a display device with excellent display quality, reliability, and productivity without generating air bubbles between a display panel and a transparent member.

### BRIEF DESCRIPTION OF THE DRAWINGS

FIG. 1 is a cross-sectional view of a display device.

FIG. 2 is a perspective view showing one embodiment of a display device.

FIG. 3 is a perspective view showing another embodiment of a display device.

FIG. 4 is a cross-sectional view of a conventional liquid crystal display device.

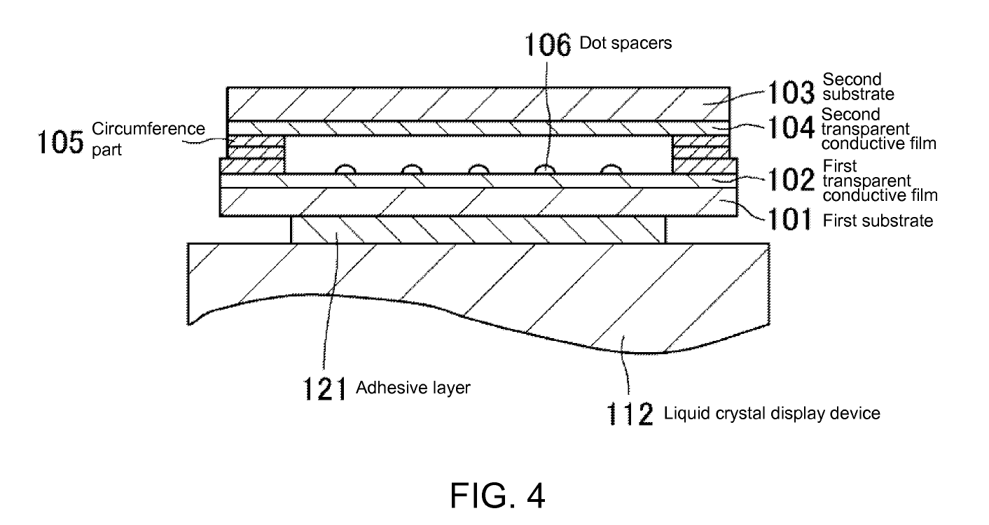

### DETAILED DESCRIPTION OF EMBODIMENTS

### Embodiment 1

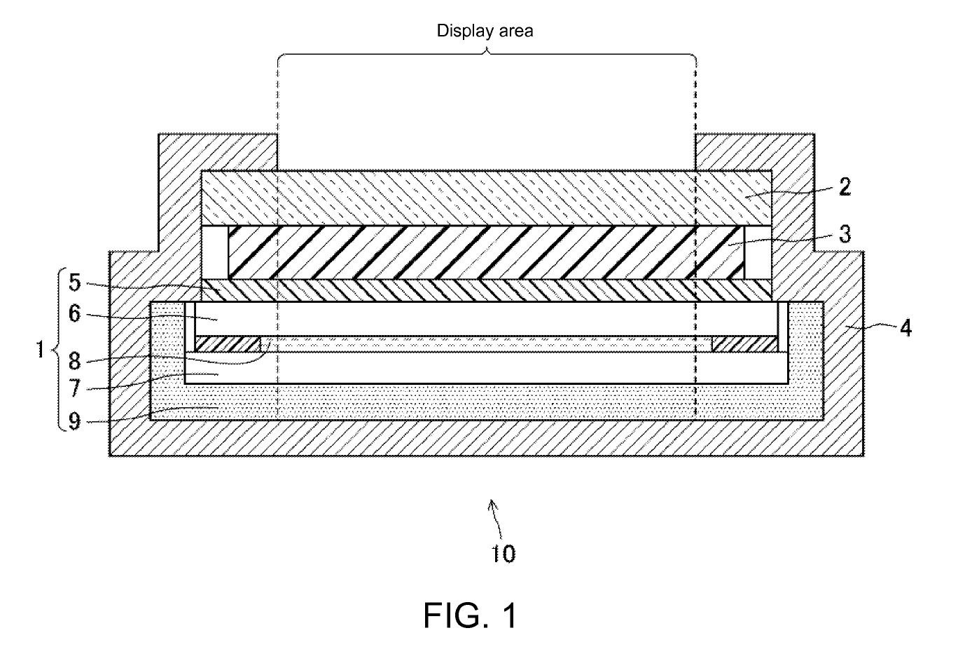

FIG. 1 is a cross-sectional view of a display device 10. Using FIG. 1, a structure of the display device 10 according to the present invention will be described.

The display device 10 of the present invention is constituted of a display panel 1, a transparent member 2, a transparent resin sheet 3, and a shrinkable case 4, and is housed in the shrinkable case 4 while having the transparent resin sheet 3 held between the liquid crystal panel 1 and the transparent member 2.

The display panel 1 is a liquid crystal panel constituted of a polarizer 5, a CF (Color Filter) substrate 6, a TFT (Thin Film Transistor) substrate 7, a liquid crystal layer 8, which is kept between the CF substrate 6 and the TFT substrate 7, and a backlight 9, for example, and has a display area defined on an area of the-liquid crystal panel 1 that excludes the circumference part.

A transparent member 2 is a touch panel for inputting a coordinate position by pressing operation or light-blocking operation with a pen or a finger performed in correspondence with the contents displayed on the display panel 1. The transparent member 2 has an input area (not shown) that corresponds to the above-mentioned display area. Below, a touch panel will be explained as an example.

A transparent resin sheet 3 is a sheet-like member made of a material with good transparency and softness, such as polyurethane, which is a high viscosity gel material, soft vinyl chloride, transparent polyimide, and the like, and has a thickness of about 0.5 mm to about 5 mm. The transparent resin sheet 3 is formed or cut out into a size larger than the display area of the display panel 1. Moreover, the transparent resin sheet 3 does not include adhesive agent for bonding, but the softness of the transparent resin sheet 3 itself makes it attachable and fixable to other members. The softness of the resin sheet 3 can be adjusted by the amount of the plasticizer mixed to the resin, and is set to a consistency level that achieves satisfactory adhesion.

As the material for the shrinkable case 4, a heat shrink material, such as silicon rubber, polyolefin, elastic neoprene, fluoroplastic Kynar, fluoroplastic Teflon, TFE (tetrafluoroethylene), or the like, is used for example. A heat shrink material is a material that shrinks at a shrinking rate of about 50% when it is heated to about 100° C. The shrinkable case 4 is formed by forming the above-mentioned heat shrink material into a case shape conforming to the shape of the display panel 1 and the transparent member 2. The shrinkable case 4 has an inner space slightly larger than the exterior dimensions of the display panel 1, the transparent member 2, and transparent resin sheet 3 so that it can house them in their stacked state.

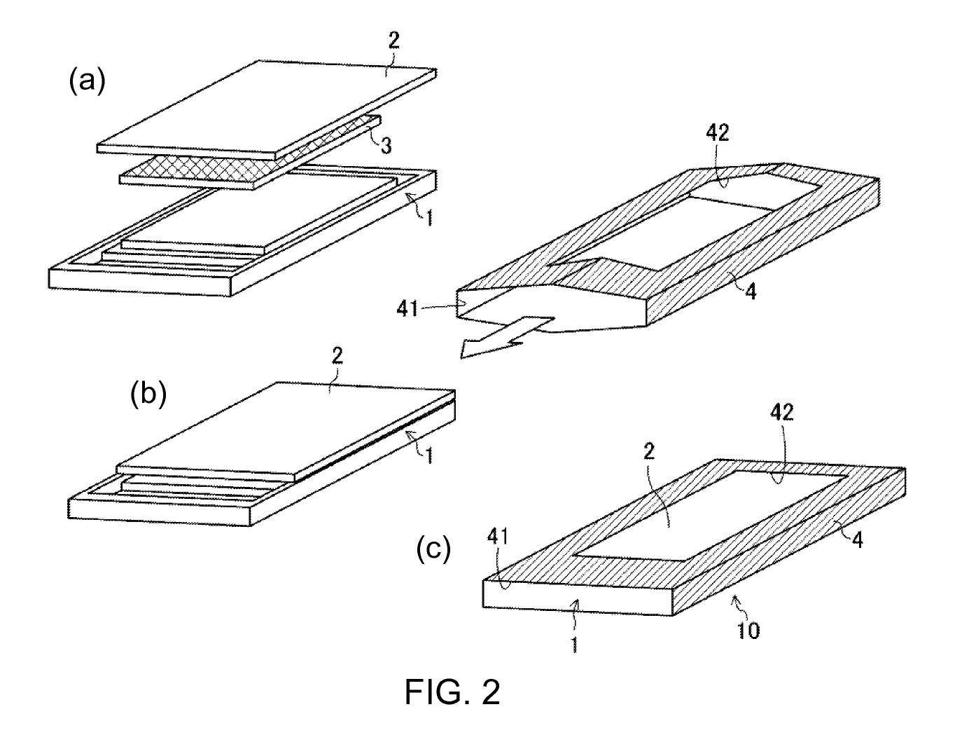

FIGS. 2(a) to 2(c) are perspective views showing one embodiment of the display device. Referring to FIG. 1 and FIGS. 2(a) to 2(c), assembly of the display device 10 according to the present invention will be described.

As shown in FIG. 1 and FIG. 2(a), in the display device 10, a transparent resin sheet 3 is placed on the display panel 1 so as to cover the display area, and a transparent member 2 is placed thereover across the transparent resin sheet 3, thereby creating a stacked structure. If the transparent member 2 is a touch panel, these components are position such that the display portion of the display panel 1 and the operation portion of the transparent member 2 are aligned to each other. Here, it is preferable that the display panel 1 and the transparent member 2 have a positioning mechanism, such as fitting parts or the like, to prevent position misalignment of the display panel 1 and the transparent member 2 within the shrinkable case 4.

In the display device 10, when stacking the display panel 1, the transparent member 2, and the transparent resin sheet 3 together, an adhesive agent is not included in the transparent resin sheet 3. Because of this, even if air bubbles are generated between the display panel 1 and the transparent member 2, the air bubbles can easily be pushed away to the outside of the display area, thereby eliminating air bubbles residues.

As shown in FIG. 2(b), the stacked display panel 1, the transparent member 2, and the transparent resin sheet 3 are inserted to the shrinkable case 4 from an insertion opening 41 provided on one side of the shrinkable case 4 and is housed therein.

After the display panel 1, the transparent member 2, and the transparent resin sheet 3 are housed in the shrinkable case 4, the heat shrink material of the shrinkable case 4 is heated to a temperature that effectuates heat shrinkage, for example, 100° C., by a heater such as a heat gun. Due to the shrinkage of the heat shrink material, the display panel 1, the transparent member 2, and the transparent resin sheet 3 are pressed in the shrinkable case 4 and are unified as shown in FIG. 2(c).

The shrinkable case 4 is provided with a window 42 at the location that corresponds to the display area (the input area of the transparent member 2) of the display panel 1. In the unified display device 10, the displayed contents of the display panel 1 can be checked and the transparent member 2 can be operated from the window 42 on the shrinkable case 4. Besides, the window 42 may be provided by cutting out the heat shrink material after the heat shrink material was shrunk by heat.

In the display device 10 of the present invention, the soft transparent resin sheet 3 placed between the display panel 1 and the transparent member 2 is pressed between these display panel 1 and transparent member 2 and is elastically deformed. Therefore, even if the display panel 1 and the transparent member 2 have irregularities on the respective surfaces, the transparent resin sheet 3 fits firmly along the irregularities. As a result, the display panel 1 and the transparent member 2 can be put together without generating air bubbles between them.

Furthermore, by providing a volatile solvent or water between the display panel 1 and the transparent resin sheet 3 or between the transparent member 2 and the transparent resin sheet 3, the adhesion of the transparent resin sheet 3 can be further enhanced. Specifically, by providing water droplets evenly on the entire adhesive surface using an atomizer and the like, when the heat shrink material is shrunk by heat and the transparent resin sheet 3 is pressed and attached between the display panel 1 and the transparent member 2, the solvent or the water existing between the adhesive surfaces is expelled to the exterior to the adhesive surfaces while taking in the air residue on the adhesive surfaces. This eliminates air bubble residues, and adhesion of transparent resin sheet 3 is further improved. Here, since the added solvent or the water is vaporized when the heat shrink material is heated, there is no risk of affecting insulation property and corrosion resistance.

In the display device 10, the display panel 1, the transparent member 2, and the transparent resin sheet 3 are bonded to each other and unified. Thus, by using materials having similar refractive indices in the respective members, the optical consistency can be ensured; the interface reflection can be reduced; and the light reflection between the transparent member 2 and the display panel 1 can be reduced. As a result, the visibility of the display state can be improved.

Furthermore, in the display device 10, the flexible transparent resin sheet 3 functions as a shock-absorbing layer between the display panel 1 and the transparent member 2. Therefore, external force is not directly transmitted to the display panel 1. For example, the force of pressing the input area on the touch panel, which is a transparent member 2, is absorbed by the transparent resin sheet 3, and the force is not transmitted directly to the liquid crystal panel, which is the display panel 1. Therefore, the display does not get blurred due to a cell gap change on the liquid crystal panel, maintaining a good display condition even when the touch panel is operated.

Furthermore, in the display device 10, if the display panel 1 and the transparent member 2 need to be replaced, the display panel 1, the transparent resin sheet 3, and the transparent member 2 can be withdrawn from the shrinkable case 4, releasing the pressure that has been binding the display panel 1, the transparent resin sheet 3, and the transparent member 2. Thus, they can be easily separated without leaving residues of adhesive agent on the display panel 1 or the transparent member 2. Additionally, the transparent resin sheet 3 is not provided with adhesive agent. Therefore, it can be used repeatedly.

Once the heat shrink material used for the shrinkable case 4 is shrunk by heat, the display device 10 stably maintains its shape established upon the heat shrinkage at any temperature within the operating temperature range of the display device 10. Therefore, the display panel 1 and the transparent member 2 housed in the shrinkable case 4 continue to be pressed onto and attached to the transparent resin sheet 3, preventing generation of new air bubbles. Moreover, the shrinkable case 4 is electrically insulating as well as waterproof. This improves the reliability of the display device 10.

Thus, the display device 10 of the present invention provides a liquid crystal display device with excellent display quality, productivity, and reliability without generating air bubbles between the display panel 1 and the transparent member 2.

### Embodiment 2

A display device according to Embodiment 2 has a shrinkable case 4 made of a heat shrink material having a light blocking property in the configuration of Embodiment 1. Since the other constituent elements are the same as those of Embodiment 1, duplicative explanations will be omitted.

A display device in Embodiment 2 uses a shrinkable case 4 made of a black heat shrink film. In the display device covered by the shrinkable case 4, the shrinkable case 4 blocks the light on the area in the vicinity of the display area. Therefore, a degradation of the display quality due to the light leakage can be avoided.

In order to block light leakage from the insertion opening 41 in the shrinkable case 4, only the window 42 may be provided in the shrinkable case 4 as an opening, and the stacked display panel 1, the transparent member 2, and the transparent resin sheet 3 may be inserted through the window 42. This way, the light leakage from the end face of the display panel 1 that would have faced the insertion opening 41 is also prevented. Thus, light leakage in all the areas other than the display area can be prevented even without an exterior case. Therefore, an exterior case can be omitted, and the display device can be manufactured at low cost, and can be made lightweight.

### Embodiment 3

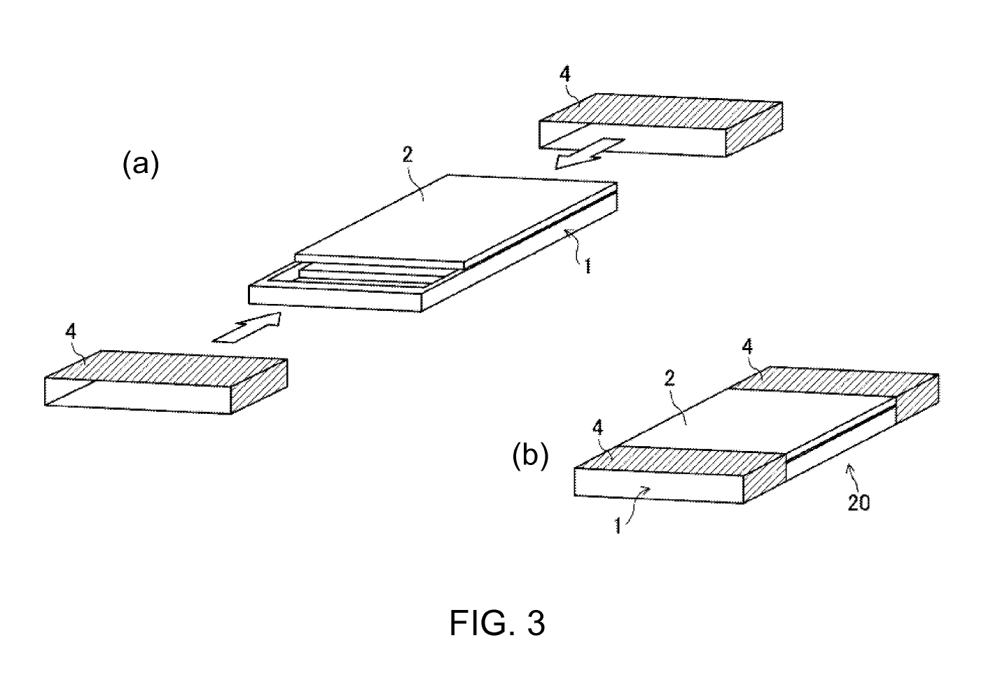

FIGS. 3(a) to 3(b) are perspective views explaining another embodiment of the display device. Referring to FIGS. 3(a) to 3(b), assembly of a display device 20 according to Embodiment 3 will be described.

In a display device 20 of Embodiment 3, a plurality of shrinkable cases 4 made of a heat shrink material are put together and unified in the configuration of Embodiment 1. Since the other constituent elements are the same as those of Embodiment 1, duplicative explanations will be omitted.

In the display device 20, the plurality of shrinkable cases 4 made of a heat shrink material are used. For example, as shown in FIGS. 3(a) to 3(b), two shrinkable cases 4 each formed in a ring shape are arranged and combined at the respective ends of the long sides of the display device 20. The ring-shaped shrinkable cases 4 can utilize a commercially available heat shrink tube that has been cut into ring-shaped slices, for example. This way, the part cost can be reduced. Moreover, the amount of the shrinkable cases 4 to use can be reduced, and as a result, the display device 20 can be made lightweight.

Furthermore, the shrinkable cases 4 can be put over the display panel 1, the transparent resin sheet 3, and the transparent member 2 from the respective side ends while holding the center of the stacked parts. Therefore, it becomes unlikely that the positions of the display panel 1 and the transparent member 2 are misaligned, providing the improved workability.

Moreover, by progressively heat-shrinking a plurality of heat shrinkable cases 4 made of a heat shrink material, the unification/assembly can be achieved without generating air bubbles. In the case of the above-mentioned example, first, the heat shrink material of one of the shrinkable cases 4 disposed at two locations is shrunk by heat in such a way that the display panel 1, the transparent resin sheet 3, and the transparent member 2 are being affixed to each other gradually and progressively from one end to the other end, pushing and eliminating the air that is present on the adhesive surfaces to the other end. Then, the heat shrink material of the other one of the shrinkable cases 4 is shrunk by heat so that the display panel 1, the transparent resin sheet 3, and the transparent member 2 are affixed to each other on their entire surfaces. This way, unification/assembly can be realized without generating air bubbles.

In the display device 20 in Embodiment 3, a heat shrink material with a light blocking property may be used for the plurality of shrinkable cases 4 in the same way as Embodiment 2. The light tends to leak especially from the place at which the light source of the backlight of the liquid crystal panel is disposed. Thus, by strategically placing some of the plurality of shrinkable cases 4 at the place(s) of the backlight for light shielding, light leakage can be reduced. Furthermore, in order to further enhance the light shielding effects, some of the plurality of the shrinkable cases 4 may be formed in a cap shape to cover the end surfaces of the display panel 1, the transparent resin sheet 3, and the transparent member 2, respectively, to block the leaked light at the respective end surfaces.

Furthermore, the plurality of shrinkable cases 4 may be arranged so as to overlap one another. For example, the shrinkable cases 4 may be arranged to cross each other to the extent they do not block the display area, or the shrinkable cases 4 may be doubly provided where a stronger affixation is desired, in order to enhance the strength of the display device 20 after the unification/assembly.

In the Embodiments 1 to 3, as a display panel 1, not only a liquid crystal panel, but also various other display panels, such as an EL (Electro Luminescence), an FED (Field Emission Display), a PDP (Plasma Display Panel), an electronic paper, and the like, can be used.

In addition, as a transparent member 2, not only a touch panel, but also a cover glass to protect the display panel 1, a prism lens to increase display quality, and the like, can be used.

### INDUSTRIAL APPLICABILITY

A display device of the present invention can be widely applied to display devices provided with a transparent member of various kinds on its display panel. The transparent member may be not only a touch panel, but also a cover glass to protect the display panel, prism lens, and the like.

### Description of Reference Characters

1 display panel
2 transparent member
3 transparent resin sheet
4 shrinkable case
5 polarizer
6 CF substrate
7 TFT substrate
8 liquid crystal layer
9 backlight
10, 20 display device
41 insertion opening
42 window

1. A display device, comprising a display panel; a transparent member; a transparent resin sheet disposed between said display panel and said transparent member for bonding said display panel and said transparent member; and a shrinkable case made of a heat shrink material that unifies said display panel and said transparent member therein.

2. The display device according to claim 1, wherein said shrinkable case has a light blocking property.

3. The display device according to claim 1, wherein said shrinkable case comprises a plurality of parts.

4. The display device according to claim 1, wherein said transparent member is a touch panel.
